(19) United States
(12) Patent Application Publication
(10) Pub. No.: US 2006/0002105 A1
(43) Pub. Date: Jan. 5, 2006

(54) LED-illuminated spa jet

(75) Inventor: Francisco Hinojosa JR., Santa Paula, CA (US)

Correspondence Address: KOPPEL, JACOBS, PATRICK & HEYBL, 555 ST. CHARLES DRIVE, SUITE 107, THOUSAND OAKS, CA, 91360, US

(73) Assignee: B&S PLASTICS, INC. dba WATERWAY PLASTICS

(21) Appl. No.: 11/173,084

(22) Filed: Jul. 1, 2005

Related U.S. Application Data
(60) Provisional application No. 60/585,017, filed on Jul. 2, 2004.

(51) Int. Cl. F21V 33/00

(52) U.S. Cl. 362/101

(57) ABSTRACT

A light for a spa jet or like water reservoir component comprises a component body adapted to project through a wall of a reservoir, and a probe within the component body arranged to receive light from an LED within the probe, the probe being adapted to transmit the light from the LED into the reservoir.

This application U.S. Provisional Patent Application Ser. No. 60/585,017 filed on Jul. 2, 2004

### FIELD OF THE INVENTION

The present invention relates generally to the illumination of pools, spas, and like systems, and particularly to the illumination of such systems utilizing light emitting diodes (LEDs).

### BACKGROUND OF THE INVENTION

Water reservoirs such as pools and spas are commonly constructed with one or more underwater light sources for illuminating the water within the reservoir. The light sources are visually appealing and the illumination of the water allows for safe use of the pool or spa at night. Conventional lighting units are commonly mounted on the wall of the pool or spa, and comprise a watertight housing that contains an incandescent light source. On one side of the housing is an aperture for the power connection to the light source, and on the other side is a lens to scatter, direct or focus the light from the light source. Each lighting unit requires its own mounting hole in the wall of the pool or spa and its own power connection.

A number of variations of conventional pool or spa lighting systems have been developed; see, for example, U.S. Pat. Nos. 4,617,615; 5,122,936; and 5,051,875.

One of the disadvantages of the illumination systems disclosed in the aforementioned patents is that a separate hole must be created in the wall of the pool or spa for either mounting the light or allowing the light's power connection to pass through the wall. The greater the number of holes in a pool or spa wall, the greater the danger of water leaking through a hole. Another disadvantage of the above systems is that when an individual light fails, it can be difficult to repair. The process can require lowering the water level to repair the light from the water side of the pool or spa. Alternatively, the light can be accessed from the exterior side of the pool or spa, but that often requires removing decking, excavating soils and/or cutting through insulation. Another disadvantage of conventional systems is that by having a high voltage light source close to the water, a short circuit can occur between the light source and the water. This is particularly a problem if there is a crack in the light's housing. As the number of lights is increased, the total potential current leakage from all of the lights increases.

Fiber optic lighting systems have been developed for spas by, among others, Coast Spas located in British Columbia, Canada. These systems include a remote light source and numerous optical fiber bundles for transmitting light from the source to a number of holes in the spa wall. Each hole has a cap to hold one of the optical fiber bundles so that the light emitted from the end of the bundle is directed through the cap and into the water within the spa. Each cap has a transparent lens that disperses or focuses the light from the fiber bundle. Although eliminating the need for electrical wiring to the points of illumination in the spa wall, these systems typically require dozens of holes in the spa wall for receiving the ends of the optical fiber bundles. The provision of numerous holes in the wall of a spa increases the spa's complexity, cost and chances of water leakage.

An improved fiber optic illumination system is disclosed in U.S. Pat. No. 6,510,277 (“Pool and Spa Components With Fiber Optic Illumination”) issued Jan. 21, 2003, to the assignee of the present invention; that patent is incorporated herein by reference in its entirety. The system of the '277 patent provides a component, such as, for example, a jet or drain, for a pool, spa or like reservoir, which component incorporates at least one fiber optic probe optically coupled via a fiber optic bundle to a remote light source that provides illumination of the water. Among other advantages, this system eliminates the need for multiple holes in the wall of the spa or pool. Nevertheless, the system requires the routing of relatively expensive fiber optic bundles and couplers to the individual jets, drains, etc. Thus, it would be desirable to further reduce the cost of spa or pool illumination systems without unduly compromising the advantages gained by a fiber optic system such as that of the '277 patent.

### SUMMARY OF THE INVENTION

In accordance with one specific, exemplary embodiment of the present invention, there is provided a light comprising a body and a probe within the body arranged to receive light from an LED within the probe, the probe being adapted to transmit the light from the LED out of the body. Pursuant to another, specific aspect of the invention, there is provided a light for a water reservoir, the light comprising a reservoir component having a body adapted to project through a wall of the reservoir, and a probe within the component body arranged to receive light from an LED within the probe, the probe being adapted to transmit the light from the LED into the reservoir.

Pursuant to another, specific aspect of the invention, there is provided a jet comprising a jet body; a water inlet to the body; a water nozzle within the body for forming water flowing through the inlet into a stream; an elongated, tubular probe mounted within the jet body along its longitudinal axis, the probe extending from the rear of the body toward its front and being at least partially transparent at its front end; and an LED mounted within the tubular probe, the light from the LED being directed through the probe and emitted from the jet body.

In accordance with yet another specific, exemplary embodiment of the present invention, there is provided a system comprising a reservoir for holding water, the system comprising at least one component having a body adapted to extend through a wall of the reservoir with the majority of the body positioned behind the wall of the reservoir; a water pump system for circulating water between the reservoir and the at least one component; an electrical power supply; an LED housed within a probe carried by the at least one component; and an electrical conductor connecting the power supply and the LED, the light from the LED passing through the probe and into the reservoir.

### BRIEF DESCRIPTION OF THE DRAWINGS

The foregoing and other objects, features and advantages of the invention will become evident to those skilled in the art from the detailed description of the preferred embodiments, below, taken together with the accompanying drawings, in which:

FIG. 1 is a perspective view of a spa system incorporating an LED-illuminated spa jet in accordance with one specific exemplary embodiment of the invention;

FIG. 2 is an exploded, perspective view of the spa jet incorporated in the system shown in FIG. 1; and

FIG. 3 is an axial cross section view of the spa jet depicted in FIG. 2.

### DETAILED DESCRIPTION OF THE INVENTION

The following description presents a preferred embodiment of the invention representing the best mode contemplated for practicing the invention. This description is not to be taken in a limiting sense but is made merely for the purpose of describing the general principles of the invention whose scope is defined by the appended claims.

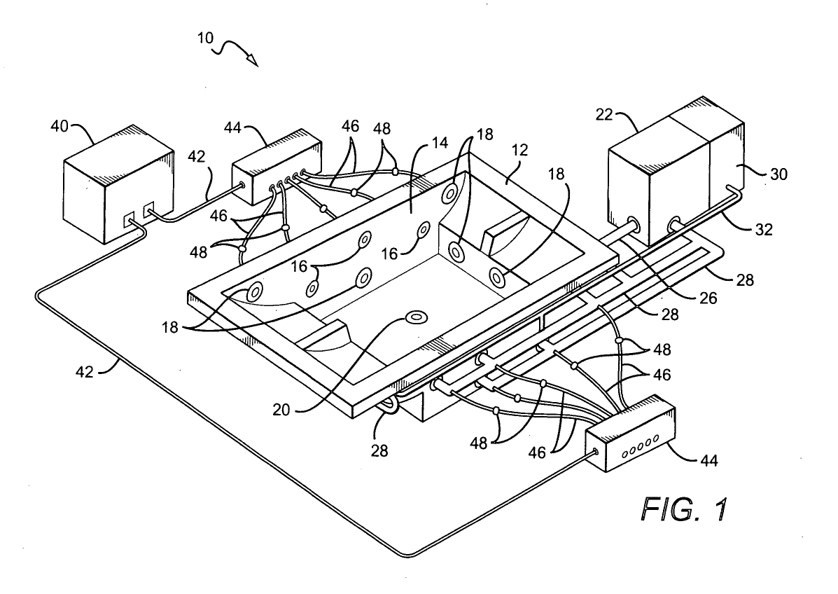

Referring to FIG. 1, there is shown a spa, pool, or like system 10 comprising a shell or reservoir 12 having a wall 14 carrying multiple illuminatable components comprising, by way of example and not limitation, stationary water jets 16, pulsating water jets 18 and a drain 20. The present invention can be used with many other components or devices, including but not limited to skimmers, point lights, control knobs, etc.

Operation of pools, spas and the like are generally known and only briefly discussed herein. The jets 16 and 18 are connected to a water pump 5 system 22 that circulates water through a series of water conduits. Water from the reservoir 12 is returned to the pump system 22 via the drain 20 and a return conduit 26. Water from the pump system 22 is delivered back to the reservoir 12 through supply conduits 28, and flows through the jets 16 and 18 into the interior of the reservoir 12, completing the loop. Additionally, an air system 30 may be included for providing air to the jets through an air conduit 32 to aerate the water flowing through the jets. The air system 30 may be pump driven to increase the pressure of the air entering the jets, or the system may be vacuum-based with a venturi or eductor located within each jet to draw air into the water stream discharged from the jet.

A remote, low voltage electrical power source 40 is connected to solid state light sources carried by the jets and/or by any other desired component such as the drain 20 by main electrical power supply lines 42, electrical power distribution circuitry 44, and individual supply lines 46 each including an electrical coupler 48 that can be disconnected to facilitate servicing of the associated component 16, 18 or 20. Low voltage is a voltage level generally known in the lighting industry and it is understood that in alternative embodiments the power source 40 can supply different levels of power including what is known in the art as high voltage. The power source can also be provided with circuitry and controls to vary the voltage level and to provide different pulsing voltages to give different lighting effects.

The solid state light sources can be many different sources including but not limited to lasers and LEDs or any combination thereof, with the preferred light sources being LEDs. As will be described in greater detail, each of the components carries a probe in turn carrying at least one LED. Light emitted from the at least one LED is transmitted through the probe to illuminate the water in the reservoir 12.

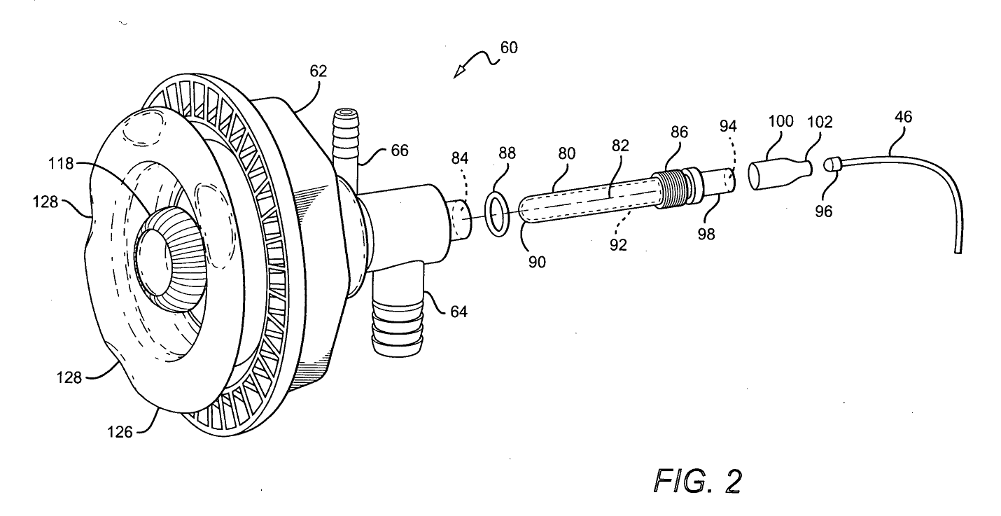

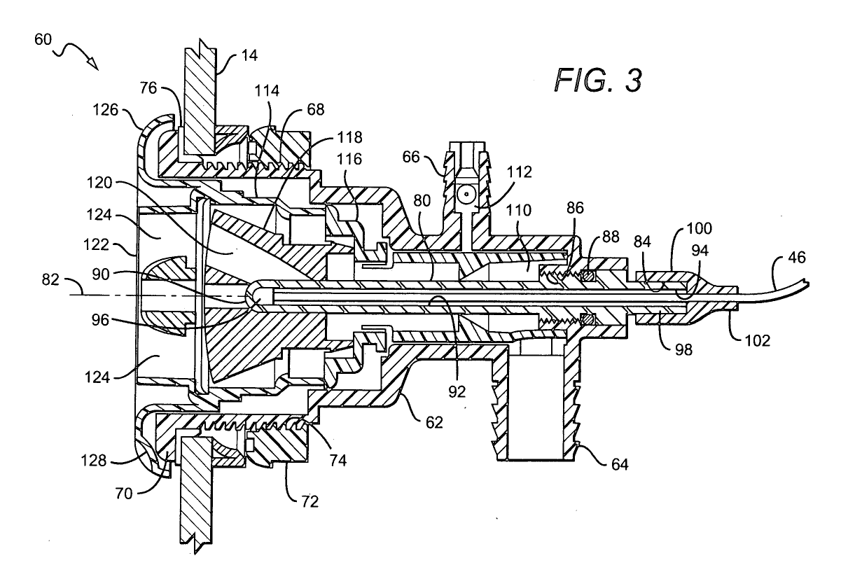

By way of example, a pulsating spa jet 60 with LED illumination constructed in accordance with the invention is shown in FIGS. 2 and 3, but it is understood that the invention can be used with many other spa components as well as devices not used in spas.. Most of the jet's components are formed from a water impervious plastic such as ABS. The jet 60 is particularly adapted to be positioned below the water line of the reservoir 12 with the majority of the jet positioned behind the reservoir's water-contacting surface of the wall 14. The jet 60 is connected to the reservoir's plumbing water supply, and the stream of air and water which is emitted is directed toward the water within the spa, all as already described.

The spa jet 60 includes a jet body 62 having a water inlet pipe 64 that receives a standard water supply line (not shown). The body 62 may also have an air inlet tube 66 to allow air into the jet body 62 when aerated water is desired. Water (or aerated water) exits the jet body through an outlet. The jet body 60 has exterior threading 68 and a front flange 70 that bears against the interior surface of the reservoir wall 14 when the jet 60 is installed. A wall fitting 72 on the exterior surface of the wall 14 opposite the front flange 70 has interior threads 74 that mate with the jet body's exterior threads 68. The wall fitting 72 is screwed into the jet body's exterior threads 68 until the flange 70 tightens against the interior surface of the spa wall 14. A gasket 76 can be included on the jet body to provide a seal between the flange 70 and the spa wall 14. The jet is held securely in place with the spa wall 14 sandwiched between the flange 70 and the wall fitting 72.

The jet body 62 carries an elongated, transparent, tubular probe 80 that runs most of the length of the jet coaxial of the jet's longitudinal central axis 82. The probe 80 is inserted into the jet through an opening 84 in the rear of the jet body 62 and secured thereto along a threaded section 86 to provide, along with an O-ring 88, a watertight seal. The tubular probe 80 comprises a closed forward end 90 and defines a central, axial passageway 92 terminating at an opening 94 that receives an LED 96 electrically connected to one of the electrical conductors 46. The LED 96 and the conductor 46 are advanced within the probe to position the LED adjacent to the closed, forward end of the probe. The probe includes a rear extension 98 that snuggly receives an elastomeric, watertight sleeve 100 having a reduced diameter portion 102 that sealingly engages the conductor 46. The LED's emission is directed toward the probe's closed end 90 so that light from the LED passes through the probe end 90 to illuminate the water within the spa.

The size of the probe 80 can be selected to match the reservoir component with which it is to be used; its dimensions are not critical to the invention. The preferred length of the probe is in the range of 7 to 13 cm; in the case of a stationary jet, the probe may extend the full length of the jet body or even project from the forward extremity of the component. Alternatively, it can be foreshortened (as shown in FIG. 3) to accommodate a rotatable jet outlet. The preferred outer diameter (for a probe with a circular cross section) is in the range of 0.5 to 2 cm. The diameter of the central passageway 92 is preferably about half the probe's outer diameter. The probe can be made of many different materials that transmit, diffuse, disperse or focus light, preferably transparent or translucent polycarbonate. Alternatively, the probe can be opaque along its entire length except for a transparent closed forward end, although it is preferably homogeneous throughout its length. Coatings, reflectors, filters and/or lenses may be incorporated in the probe for providing various optical effects.

The probe may have many different shapes and dimensions, and may be mounted within the spa jet or other component in many different ways; all of these variations will be apparent to those skilled in the art.

The individual LEDs may have various viewing angles and colors, including, for example, red, white, green and yellow and may be controlled to blink or flash. The LEDs may be high power, high intensity devices; it is preferable, however, that the LEDs be powered by low voltage AC or DC.

Water enters the jet 60 through the water inlet 64 and flows through a jet nozzle 110. Since the probe 80 is disposed within the nozzle 110, it tends to reduce the volume of water that can pass through the nozzle. As a result, the nozzle 110 should have a larger cross sectional flow area than would be the case for a conventional spa jet to allow a sufficient volume of water to pass through the jet. The interior surface of the nozzle 110 tapers inwardly in the flow direction to accelerate the water flowing through the nozzle, creating an eductor or venturi effect. A passageway 112 allows air to flow from the air inlet 66 to the forward end of the nozzle. At that location, the air is entrained into the water jet due to the eductor action, causing a desirable water/air mixture to be emitted from the jet.

Attached to the downstream end of the nozzle 110 is an eyeball carrier 114 having a bearing 116 carrying a rotatable eyeball 118 so that water entering the eyeball causes it to rotate. The eyeball 118 defines at least one water conduit 120 having a longitudinal axis offset from the eyeball's rotational axis (which coincides with the central axis 82) so that water can enter the conduit 120 around the probe so as to cause the eyeball 118 to rotate. The jet flow exiting the eyeball traces a continuous circular pattern. The eyeball 118 may define more than one conduit, but because the probe consumes space, its presence reduces the volume of water passing through the jet.

Located downstream of the eyeball 118 is a diverter cap 122 that diverts the water flowing from the eyeball to produce a series of pulsating jets. The cap 122 includes a plurality of conical bores 124 disposed in a ring around the eyeball's rotation axis 82. The bores 124 are aligned with the circular pattern of the jet flow exiting conduit 120 and emit a jet pulse each time the conduit jet passes by them. The result is a circular pattern of jet pulses that is esthetically pleasing.

The eyeball 118 is held on the bearing 116 and within the carrier 114 by the diverter cap 122. An escutcheon 126 is attached to the eyeball by a series of tabs that mate with recesses in the carrier 114. A series of depressions 128 are included around the escutcheon's perimeter for gripping. Manual rotation of escutcheon 126 rotates the carrier and the nozzle, in turn regulating the flow of water into the nozzle 110 from the water inlet 64.

As noted, light from the LED 96 exits mainly through the closed end 90 of the probe 80. In the embodiment shown, the probe does not extend the entire length of the jet, but extends only partially into the eyeball 118. The eyeball and diverter cap are made of a transparent or translucent material that allows light from the probe to enter the spa. Both the contours of the diverter cap 122 and the air and water from the jets exiting the bores 124 help refract the light. The eyeball and diverter cap can be made of many different materials, but are preferably made of an acrylic or polycarbonate.

While several illustrative embodiments of the invention have been shown and described, numerous variations and alternate embodiments will occur to those skilled in the art. Such variations and alternate embodiments are contemplated, and can be made without departing from the spirit and scope of the invention as defined by the appended claims.

What is claimed is:

1. A light for a water reservoir, comprising:
a reservoir component having a body adapted to project through a wall of the reservoir; and
a probe within said component body arranged to receive light from a solid state light source within the probe, the probe being adapted to transmit the light from said light source into said reservoir.

2. The light of claim 1, wherein said light source is a laser or LED.

3. The light of claim 1, wherein said probe is elongated and hollow along most of its length, open at one end and closed at the other end and mounted within said component with said light source mounted within said probe.

4. The light of claim 3, wherein said probe further comprises threads on its exterior surface, and said component includes an opening which receives said probe, said opening including threads along its interior surface that mate with said probe threads.

5. The light of claim 3, wherein said probe is sealed to prevent reservoir water from entering the interior of said probe.

6. The light of claim 5, wherein said probe is sealed by a watertight sleeve around said open end of said probe.

7. The light of claim 1, wherein said probe extends from the rear of said component out the front of said component.

8. The light of claim 1, wherein said probe extends from the rear of said component partially through said component toward its front, said component is transparent between the front end of said probe and the front of said component to transmit light from said probe through the front of said component.

9. The light of claim 1, wherein said probe comprises a transparent or translucent material.

10. The light of claim 1, wherein said component is one selected from the group consisting of a stationary jet, a pulsating jet and a drain.

11. The light of claim 1, wherein said component comprises a jet having a longitudinal, central axis, said probe mounted along said jet's longitudinal axis and extending from the rear of jet toward its front.

12. A jet, comprising:
a jet body;
a water inlet to said body;
a water nozzle within said body for forming water flowing through said inlet into a stream;
an elongated, tubular probe mounted within said jet body along its longitudinal axis, said probe extending from the rear of said body toward its front and being at least partially transparent at its front end; and
an solid state light source mounted within said tubular probe, the light from said light source being directed through said probe and emitted from said jet body.

13. The jet of claim 12, wherein said light source is a laser or LED.

14. The jet of claim 12, wherein said water nozzle forms an eductor and said jet body includes an air inlet for aeration of water flowing through said nozzle.

15. The jet of claim 14, wherein said probe passes through said eductor.

16. The jet of claim 12, wherein said probe includes threads on its exterior surface and said jet body further comprises an opening which receives said probe, said opening including threads along its interior surface that mate with said probe threads.

17. The jet of claim 12, wherein said probe protrudes past the front of said jet body.

18. The jet of claim 12, wherein said probe extends partially along said longitudinal axis and terminates short of the jet's front end, said jet being transparent between its front and the end of said probe to transmit light from said probe out its front.

19. The jet of claim 12, wherein said probe is elongated and hollow along most of its length, open at one end, and closed at the other, and said LED is housed within said probe.

20. A system comprising a reservoir for holding water, said system comprising:
at least one component having a body adapted to extend through a wall of the reservoir with the majority of said body positioned behind the wall of said reservoir;
a water pump system for circulating water between said reservoir and said at least one component;
an electrical power supply;
an LED housed within a probe carried by said at least one component; and
an electrical conductor connecting said power supply and said LED, the light from said LED passing through said probe and into said reservoir.

21. The system of claim 20, wherein said probe is elongated and its associated component includes an opening for said probe to be mounted within the component.

22. The system of claim 20, wherein said component is one selected from the group consisting of a stationary jet, a pulsating jet, a drain, a return and a skimmer.

23. A light, comprising:
a body; and
a probe within said body arranged to receive light from a solid state light source within the probe, the probe being adapted to transmit the light from said light source out of said body.

24. The light of claim 23, wherein said light source is a laser or LED.

25. The light of claim 23, wherein said probe is elongated and hollow along most of its length, open at one end and closed at the other end and mounted within said body with said light source housed within said probe.

26. The light of claim 25, wherein said probe is sealed to prevent water from entering the interior of said probe.

26. The light of claim 23, wherein said probe extends from the rear of said body out the front of said body.

27. The light of claim 23, wherein said probe extends from the rear of said body partially through said body toward its front, said body is transparent between the front end of said probe and the front of said body to transmit light from said probe through the front of said component.

28. The light of claim 23, wherein said probe comprises a transparent or translucent material.
